(19) United States
(12) Patent Application Publication
(10) Pub. No.: US 2016/0277751 A1
(43) Pub. Date: Sep. 22, 2016

(54) PACKAGING/MUX AND UNPACKAGING/DEMUX OF GEOMETRIC DATA TOGETHER WITH VIDEO DATA

(71) Applicants: Patrick J. Sweeney, Woodinville, WA (US); Yongjun Wu, Bellevue, WA (US); Shyam Sadhwani, Bellevue, WA (US)

(72) Inventors: Patrick J. Sweeney, Woodinville, WA (US); Yongjun Wu, Bellevue, WA (US); Shyam Sadhwani, Bellevue, WA (US)

(21) Appl. No.: 14/663,364

(22) Filed: Mar. 19, 2015

(51) Int. Cl. H04N 19/169; H04N 19/12; H04N 19/70; H04N 19/172

(52) U.S. Cl. CPC H04N 19/188; H04N 19/172; H04N 19/12; H04N 19/70

(57) ABSTRACT

Technologies are described herein for providing enhanced packaging, coding, decoding and unpackaging of geometric data. In some configurations, geometric data is obtained by a device. The geometric data is partitioned into data partitions representing reconstruction information for video frames. The data partitions representing frames are then converted and integrated into a network abstraction layer of a bit stream. Geometric data may be obtained from the bit stream by accessing the data partitions from the network abstraction layer. The data partitions can be then processed into geometric data for further processing, such as the reconstruction, generation, display or processing of a three dimensional (3D) object modeled by the geometric data.

### BACKGROUND

Some technologies, such as those defined by the SMPTE VC-1, H.264/AVC, and HEVC standards, etc., are designed to provide many benefits for a wide range of applications that include video and audio communication services, on-demand video services, multimedia streaming services, multimedia messaging services, etc. An increasing number of services and growing popularity of portable devices are creating greater needs for higher coding efficiency and further diversification of the networks that deliver encoded data. Although there have been continued efforts to maximize coding efficiency while dealing with the diversification of network types and device types, there are a number of shortcomings that have not been addressed.

Among many shortcomings of existing designs, current technologies do not provide solutions that enable efficient packaging, communication and processing of geometric data. Some coding and decoding technologies offer some solutions for processing generic payloads, however these universal solutions do not allow all devices and applications to utilize all of the processed data in some circumstances. This is a particular issue with respect to the processing of geometric data.

It is with respect to these and other considerations that the disclosure made herein is presented.

### SUMMARY

Technologies are described herein for providing enhanced packaging, coding and decoding of geometric data. In some configurations, geometric data is obtained by a device. The geometric data is partitioned into data partitions enhancing and reconstructing objects from frames. The data partitions representing frames' geometric data are then integrated into a network abstraction layer (NAL) of a bit stream. Geometric data may be obtained from the bit stream by accessing the data partitions from the network abstraction layer. The data partitions can be then processed into geometric data for further processing, such as the generation, display or processing of a two-dimensional (2D) or three-dimensional (3D) object modeled by the geometric data. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing several example components of a system for providing enhanced coding and decoding of geometric data.

FIG. 2 illustrates a bit stream including geometric data and video data that is parsed from media having a number of frames.

FIG. 3 illustrates another example of a bit stream including geometric data and video data including a sequence header, a picture header and multiple slice headers.

FIG. 4A is a flow diagram showing aspects of a routine disclosed herein for encoding geometric data and video data into a NAL of a bit stream.

FIG. 4B is a flow diagram showing aspects of a routine disclosed herein for decoding a bit stream containing geometric data and video data.

FIG. 5 is a computer architecture diagram illustrating an illustrative computer hardware and software architecture for a computing system capable of implementing aspects of the techniques and technologies presented herein.

FIG. 6 is a diagram illustrating a distributed computing environment capable of implementing aspects of the techniques and technologies presented herein.

FIG. 7 is a computer architecture diagram illustrating a computing device architecture for a computing device capable of implementing aspects of the techniques and technologies presented herein.

### DETAILED DESCRIPTION

Technologies are described herein for providing enhanced packing, coding, decoding, unpackaging of geometric data. In some configurations, geometric data is obtained by a device. The geometric data is partitioned into data partitions representing geometric data for frames. The data partitions representing frames are then converted and integrated into a network abstraction layer of a bit stream. In some other video standard, frames may be integrated into some other packet as specified by that standard. Geometric data may be obtained from the bit stream by accessing the data partitions from the network abstraction layer. It can be appreciated that some video standards may use a different syntax than network abstraction layer for storing packets and those technologies may be used with the concepts disclosed herein. The data partitions can be then processed into geometric data for further processing, such as the reconstruction, generation, display or processing of a 2D or 3D object modeled by the geometric data.

It should be appreciated that the above-described subject matter may be implemented as a computer-controlled apparatus, a computer process, a computing system, or as an article of manufacture such as a computer-readable storage medium. Among many other benefits, the techniques herein improve efficiencies with respect to a wide range of computing resources. Enabling the processing of geometric data in the manner described herein reduces the need for specialized devices or software applications to access and process geometric data. By allowing the use of efficient and widely adopted codecs, network resources and computing resources are used more efficiently. In addition, human interaction with the device may be improved as the use of the techniques herein enable efficient use of popular codecs with geometric data without requiring a user to manage, design and conform devices or software applications to access and process geometric data.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like. It can also be appreciated that the concepts described herein are applicable to any other coding formats, including standards-based or private video coding formats, such as VC-1, VP9, VP8, etc. It can also be appreciated that the techniques presented herein may be used for coding standards as well as file format standards. For example, the techniques described herein may be used for an H.264 video coding standard and an MPEG-4 file format standard.

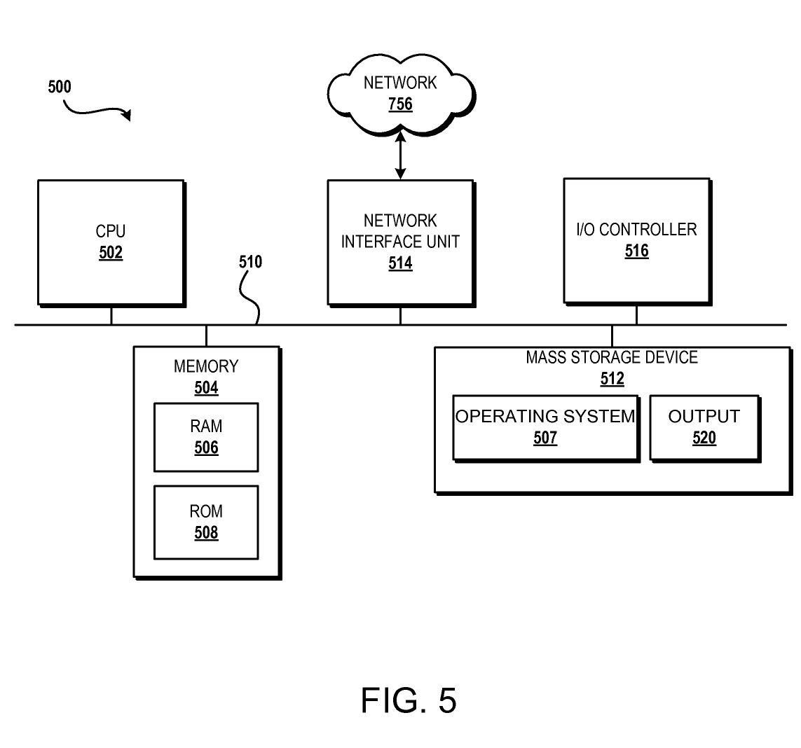

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for providing enhanced coding and decoding of geometric data. As will be described in more detail below with respect to FIGS. 5-7, there are a number of applications and services that can embody the functionality and techniques described herein.

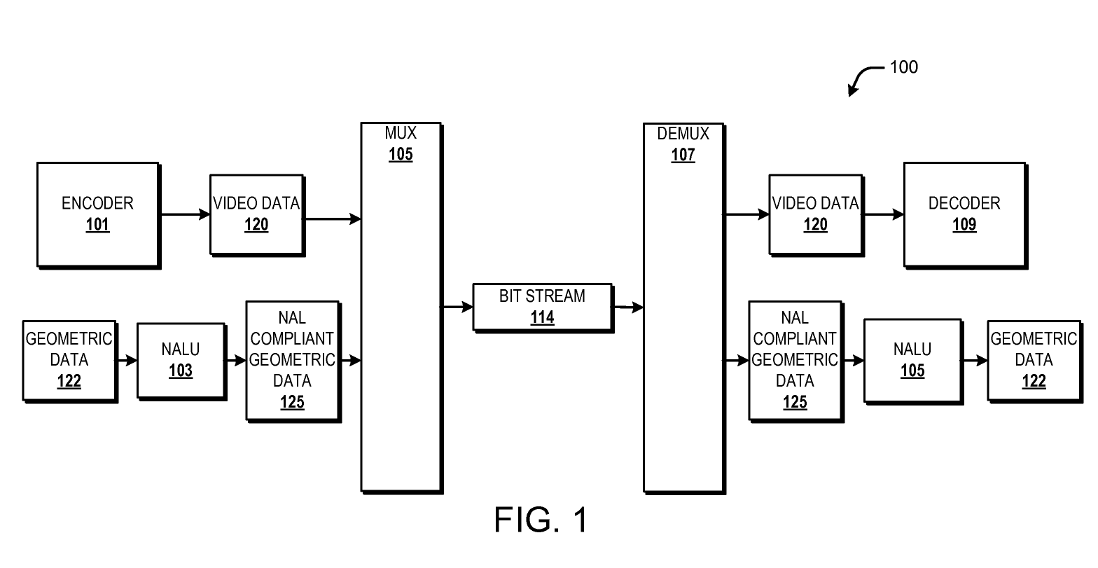

FIG. 1 is a system diagram showing aspects of one illustrative mechanism disclosed herein for providing enhanced coding and decoding of geometric data. As shown in FIG. 1, a system 100 may include an encoder 101, a first network abstraction layer unit (NALU) 103 and a multiplexer (MUX) 105, a demultiplexer (DEMUX) 107, a second NALU 105 and a decoder 109. Although the example described herein refers to a NALU, any technology may be used with the concepts disclosed herein. For instance, the NALU may also be referred to herein as a NALU/packetizer, H.264/H.265 use NALU. It can be appreciated that any other standard may use different a syntax for storing these packets.

In some configurations, the encoder 101 may include any component that generates data that complies with one or more specifications. For instance, the encoder 101 may be an H.264 encoder or a HEVC encoder configured to generate standard-compliant video data 120. For illustrative purposes, the video data 120 may is also referred to herein as “image data.” In one example, the video data 120 may include the video and/or image data of an MPEG file.

The geometric data 122 may include any form of data that defines parameters of an object. For example, geometric data 122 may include a collection of vertices, edges and faces that defines the shape of a polyhedral object in 2D or 3D computer graphics and solid modeling. The faces, for example, may include triangles (triangle mesh), quadrilaterals, or other simple convex polygons. These examples are provided for illustrative purposes and are not to be construed as limiting, as the techniques described herein may use any type of geometric data.

The first NALU 103 is configured to process the geometric data 122 to generate NAL-compliant geometric data 125. In general, the processing of the first NALU 103 adds data to the geometric data 122 to allow for the communication of the geometric data 122 in the NAL of a bit stream. As can be appreciated, the NAL operates on NAL units (NALUs) that improve transport abilities over almost all existing networks. The processing of the first NALU 103 generates the NAL-compliant geometric data 125 by adding data to the geometric data 122. For instance, the first NALU 103 may add a header and a bit string that represents the payload. The header byte itself includes an error flag, a disposable NALU flag, and the NALU type. As can be appreciated, these examples are provided for illustrative purposes and are not to be construed as limiting as other types of data may be added or modified by the NALU 103.

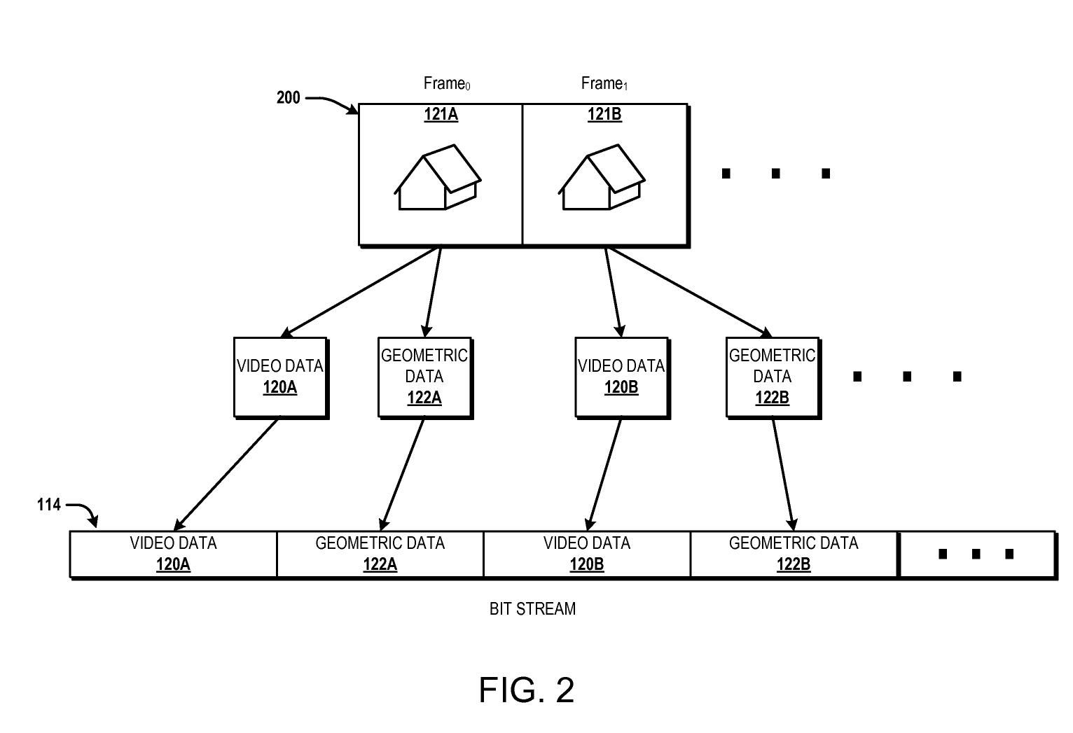

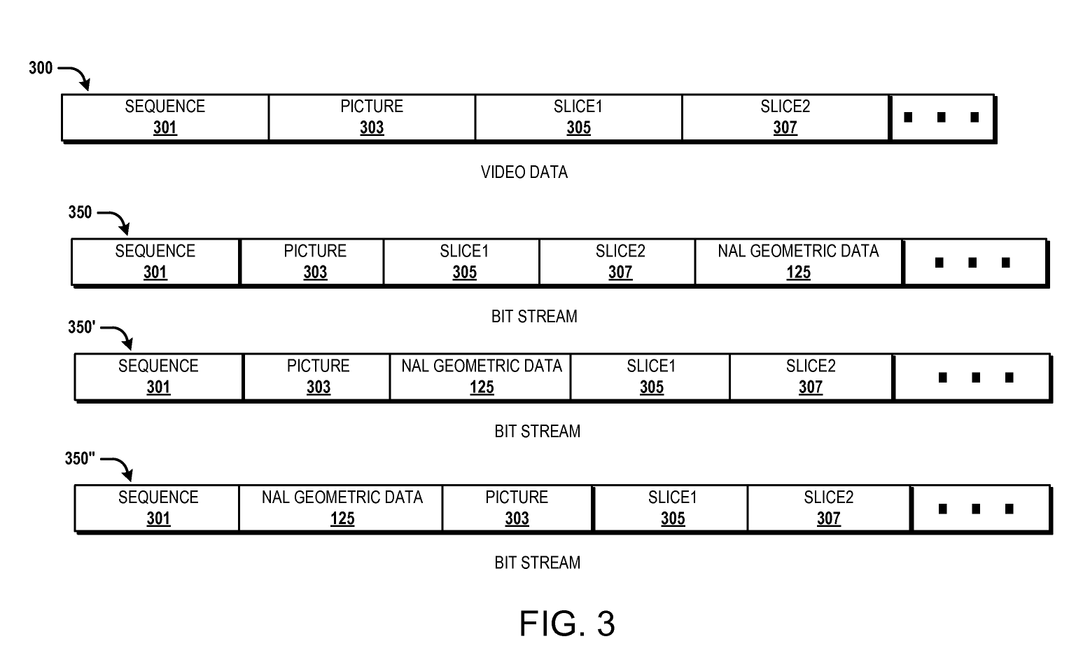

The video data 120 and the NAL-compliant geometric data 125 are then processed by the MUX 105 to generate a bit stream 114. As will be described in more detail below, some configurations involve a process of integrating partitions of the NAL-compliant geometric data and partitions of the video data into the network abstraction layer of a bit stream. By integrating the NAL-compliant geometric data 125 into the network abstraction layer of a bit stream, devices configured to interpret the NAL-compliant geometric data may obtain the geometric data without the need for special mechanisms for reading custom tracks of a bit stream. In addition, by adding the geometric data in the NAL, devices that are configured in accordance with a standard, such as H.264 or H.265, may still utilize the bit stream 114 to access video data without interference from the geometric data. More details regarding the bit stream are provided below and shown in FIG. 2 and FIG. 3. As can be appreciated, the bit stream 114 may be stored into a file and/or communicated from a first computing device to another computing device using any existing communication technologies.

Also shown in FIG. 1, the DEMUX 107 processes the bit stream 114 to extract the video data 120 and the NAL-compliant geometric data 125. Known technologies for parsing bit stream data may be used in the implementation of the DEMUX 107. The video data 120 may be then processed by a decoder 109, which may be any type of decoder, such as an H.264 decoder or an HEVC decoder. In addition, the second NALU 105 is configured to process the NAL-compliant geometric data 125 to extract the geometric data 122. In general, the second NALU 105 is configured to remove the data that was added by the first NALU 103.

Turning now to FIG. 2, aspects of the bit stream 114 are shown and described herein. As summarized above, some configurations disclosed herein involve obtaining geometric data and video data. The geometric data is processed into data partitions representing frames and the video data is processed into data partitions representing video frames. The example shown in FIG. 2 illustrate one representation of media 200, such as a video having multiple frames, e.g., frame₀, frame₁ and other frames. For illustrative purposes, frame₀ is referred to as the first frame 121A and the frame₁ is referred to as the second frame 121B. This example illustrates that a first frame, frame₀, of the media 200 may be associated with a first partition of video data 120A and a first partition of geometric data 122A. In addition, this example illustrates how a second frame, frame₁, of the media 200 may be associated with a second partition of video data 120B and a second partition of geometric data 122B.

As also summarized above, and shown in the example of FIG. 2, the video data partitions and the geometric data partitions are both integrated into the bit stream 114. In some configurations, the video data partitions 120A and 120B and the geometric data partitions 122A and 122B are integrated into the network abstraction layer of the bit stream 114. In some configurations, as shown in FIG. 2, the geometric data partitions are interleaved between the video data partitions. Although this example shows individual the geometric data partitions following individual video data partitions, in some configurations, the partitions may be sorted in other arrangements.

In some configurations, there may be a need to arrange the partitions of the video data and geometric data to accommodate one or more conditions. For instance, with reference to FIG. 2, there may be a need for a partition of geometric data to be adjacent to a partition of video data. Such an arrangement may be needed when the video data and the geometric data need to be in synchronization, e.g., having a one to one mapping with an adjacent partitions creating a super unit.

In some configurations, there may be a need to generate a bit stream having the first video data partition 120A within a threshold number of partitions from the first geometric data partition 122A. In another example, there may be a need to generate a bit stream having the delivery of first video data partition 120A within a threshold number of milliseconds from the first geometric data partition 122A. Any unit of measurement may be used to measure the distance between two or more partitions.

In some configurations, there may be a need to arrange one or more partitions of the geometric data in a position of the bit stream relative to other partitions of the geometric data. For instance, the second geometric data partition 122B may depend on the first geometric data partition 122A. In such a scenario, it may be desirable to arrange the geometric data partitions within a threshold unit of one another. For instance, the second geometric data partition 122B may be positioned in the bit stream 114 within a predetermined number of partitions from the first geometric data partition 122A. In another example, the second geometric data partition 122B may be positioned in the bit stream 114 within a threshold amount of time relative to the first geometric data partition 122A. The threshold amount of time, for example, may be a few milliseconds.

These examples are provided for illustrative purposes and are not to be construed as limiting as some partitions may depend on other partitions, or a certain arrangement of partitions may be required by one or more specifications. For instance, when compression is involved, utilization of one particular partition may rely on data from another partition. In such circumstances, the order of certain partitions may need to follow a particular sequence and/or have a particular position within the bit stream.

Turning now to FIG. 3, another example bit stream 350 generated by the techniques described herein is shown and described below. In particular, the example of FIG. 3 includes details of sample video data that is integrated into the bit stream 350. In this example, the video data 300 includes a number of partitions, which may include data defining a sequence header 301, a picture header 303 a first slice header 305 and a second slice header 307. It can be appreciated that this example is provided for illustrative purposes and is not to be construed as limiting, as the video data 300 may include many more partitions, e.g., a different number of slices and/or other header types. As shown in FIG. 3 and described below, the geometric data 122 may be positioned in different locations relative to the partitions of the video data 300.

As summarized above, the geometric data 122 may undergo processing described above to enable the communication of the geometric data 122 in the NAL. Once the geometric data 122 is formed to be NAL-compliant, partitions of the NAL-compliant geometric data 125 may be inserted in the NAL of a bit stream. The NAL-compliant geometric data 125 may be arranged within the bit stream at a number of different positions, and it may be based on whether the position conforms to a video coding standard. For instance, the first example bit stream 350 illustrates an order of partitions that includes: a sequence header 301, a picture header 303, a first slice header 305, a second slice header 307, followed by the geometric data 122. Such an arrangement may be used for configurations utilizing H.264 and H.265 technologies.

In other configurations, it is possible to place the geometric data 122 in other locations relative to the partitions of the video data 300. Such arrangements may be possible depending on the limitations and features of a coding standard. For example, a second example bit stream 350′ illustrates an order of partitions that includes: a sequence header 301, a picture header 303, the geometric data 122, a first slice header 305, and a second slice header 307. A third example bit stream 350″ illustrates an order of partitions that includes: a sequence header 301, the geometric data 122, a picture header 303, a first slice header 305 and a second slice header 307. These examples are provided for illustrative purposes and is not to be construed as limiting, as the geometric data 122 may be placed in other arrangements relative to the partitions of the video data 300. It is to be appreciated that such arrangements may be possible if they conform to one or more desired coding standards.

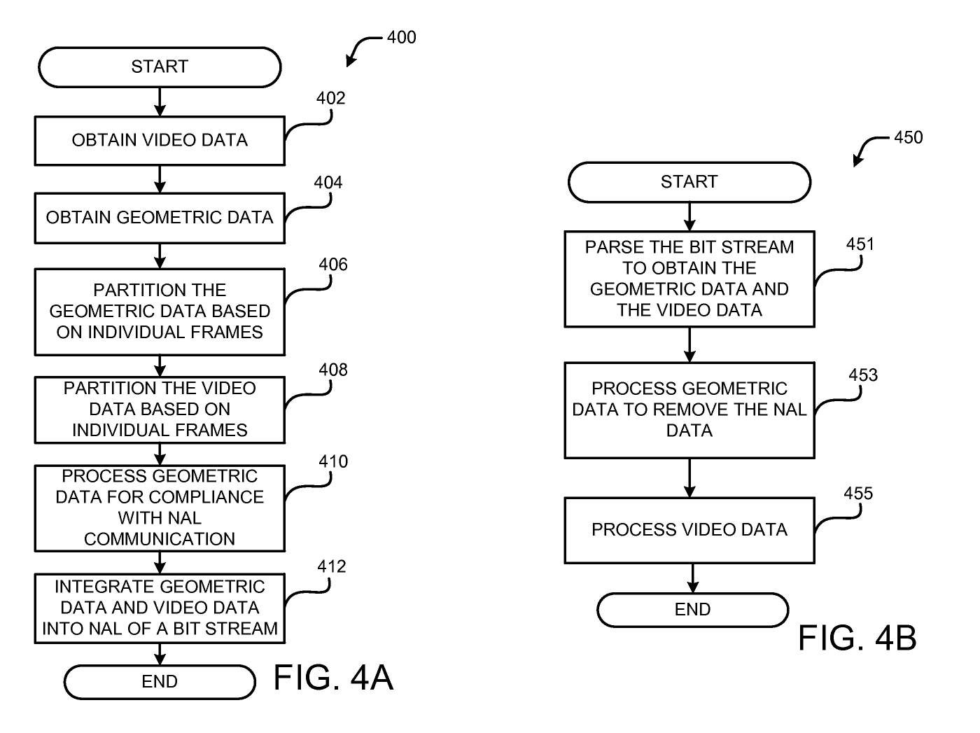

Turning now to FIG. 4A, aspects of a routine 400 for encoding geometric data and video data into a bit stream are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As will be described in more detail below, in conjunction with FIG. 1, the operations of the routine 400 are described herein as being implemented, at least in part, by an application, component and/or circuit, such as the encoder 101, NALU 103, MUX 105, DEMUX 107, and decoder 109. Although the following illustration refers to the components of FIG. 1, it can be appreciated that the operations of the routine 400 may be also implemented in many other ways. For example, the routine 400 may be implemented, at least in part, by computer processor or processor of another computer. In addition, one or more of the operations of the routine 400 may alternatively or additionally be implemented, at least in part, by a chipset working alone or in conjunction with other software modules. Any service, circuit or application suitable for providing contextual data indicating the position or state of any device may be used in operations described herein.

With reference to FIG. 4A, the routine 400 begins at operation 402, where video data 120 is obtained. The video data 120 may be in any format and may be from any resource. In one example, the video data 120 may be generated by the encoder, which may be an H.264 encoder or a HEVC encoder.

Next, in operation 404, the geometric data 122 is obtained. The geometric data 122 may include any form of data that defines parameters of an object. For example, geometric data 122 may include a collection of vertices, edges and faces that defines the shape of a polyhedral object in 3D computer graphics and solid modeling. The faces may include triangles (triangle mesh), quadrilaterals, or other simple convex polygons. These examples are provided for illustrative purposes and are not to be construed as limiting, as the techniques described herein may be used with any type of geometric data.

Next, in operation 406, the routine 400 involves a partitioning of the geometric data. In some configurations, operation 406 involves the generation of individual partitions of geometric data that are associated with individual frames. This operation may involve one or more known techniques for partitioning geometric data. For illustrative purposes, a first geometric data partition 122A associated with a first frame 121A (Frame₀) and a second geometric data partition 122B associated with a second frame 121B (Frame₁) are shown in FIG. 2.

Next, in operation 408, the routine 400 involves a partitioning of the video data. In some configurations, operation 408 involves the generation of individual partitions of the video data that are associated with individual frames of video data. This operation may involve one or more known techniques for partitioning video data. For illustrative purposes, a first video data partition 120A associated with a first frame 121A (Frame₀) and a second video data partition 120B associated with a second frame 121B (Frame₁) are shown in FIG. 2.

Next, in operation 410, the first NALU 103 processes the geometric data 122 to generate NAL-compliant geometric data 125. In general, the processing of the first NALU 103 adds data to the geometric data 122 to allow for the communication of the geometric data 122 in the NAL of a bit stream. As can be appreciated, the NAL operates on NAL units (NALUs) that improve transport abilities over almost all existing networks. The processing of the first NALU 103 generates the NAL-compliant geometric data 125 by adding data, such as header data, to the geometric data 122. For instance, the first NALU 103 may add a one-byte header and a bit string that represents the payload. The header byte itself includes an error flag, a disposable NALU flag, and the NALU type. As can be appreciated, these examples are provided for illustrative purposes and are not to be construed as limiting as other types of data may be added and/or modified by the first NALU 103.

Next, in operation 412, the video data 120 and the NAL-compliant geometric data 125 are then processed by the MUX 105 to generate a bit stream 114. Some configurations of operation 412 involve a process of integrating partitions of the NAL-compliant geometric data 125 and partitions of the video data into the network abstraction layer of the bit stream 114. By integrating the NAL-compliant geometric data 125 into the network abstraction layer of a bit stream, devices configured to process the NAL-compliant geometric data 125 may obtain geometric data without the need for special mechanisms for reading custom tracks of a bit stream. In addition, by adding the geometric data in the NAL, devices that are configured in accordance with a standard, such as H.264 or H.265, may still utilize the generated bit stream to access video data without interference from the geometric data. As can be appreciated, the bit stream 114 may be communicated from a first computing device to another computing device using any existing communication technologies.

FIG. 4B is a flow diagram showing aspects of a routine 450 disclosed herein for decoding a bit stream containing geometric data and video data. The routine 450 starts at operation 451 where the DEMUX 107 processes the bit stream 114 to extract the video data 120 and the NAL-compliant geometric data 125. Known technologies for parsing a bit stream may be used in the implementation of operation 451.

Next, at operation 453, the second NALU 105 is configured to process the NAL-compliant geometric data 125 to extract the geometric data 122. In general, the second NALU 105 is configured to remove the data, such as header data, that was added by the first NALU 103. Next, at operation 455, the video data 120 may be then subject to further processing. For instance, video data 120 processed by a decoder 109, which may be any type of decoder, such as an H.264 decoder or an HEVC decoder. Operation 455 may also involve the generation of an output (520 of FIG. 5), which can include a rending of a 3D object defined by the geometric data.

FIG. 5 shows additional details of an example computer architecture 500 for a computer, such as the computing device 101 (FIG. 1), capable of executing the program components described above for providing enhanced coding and decoding of geometric data. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing an operating system 507, data, such as an output 520, and one or more application programs.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium,” “computer-readable storage medium” and variations thereof, does not include waves, signals, and/or other transitory and/or intangible communication media, per se.

According to various configurations, the computer architecture 500 may operate in a networked environment using logical connections to remote computers through the network 756 and/or another network (not shown). The computer architecture 500 may connect to the network 756 through a network interface unit 514 connected to the bus 510. It should be appreciated that the network interface unit 514 also may be utilized to connect to other types of networks and remote computer systems. The computer architecture 500 also may include an input/output controller 516 for receiving and processing input from a number of other devices, including a keyboard, mouse, or electronic stylus (not shown in FIG. 5). Similarly, the input/output controller 516 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

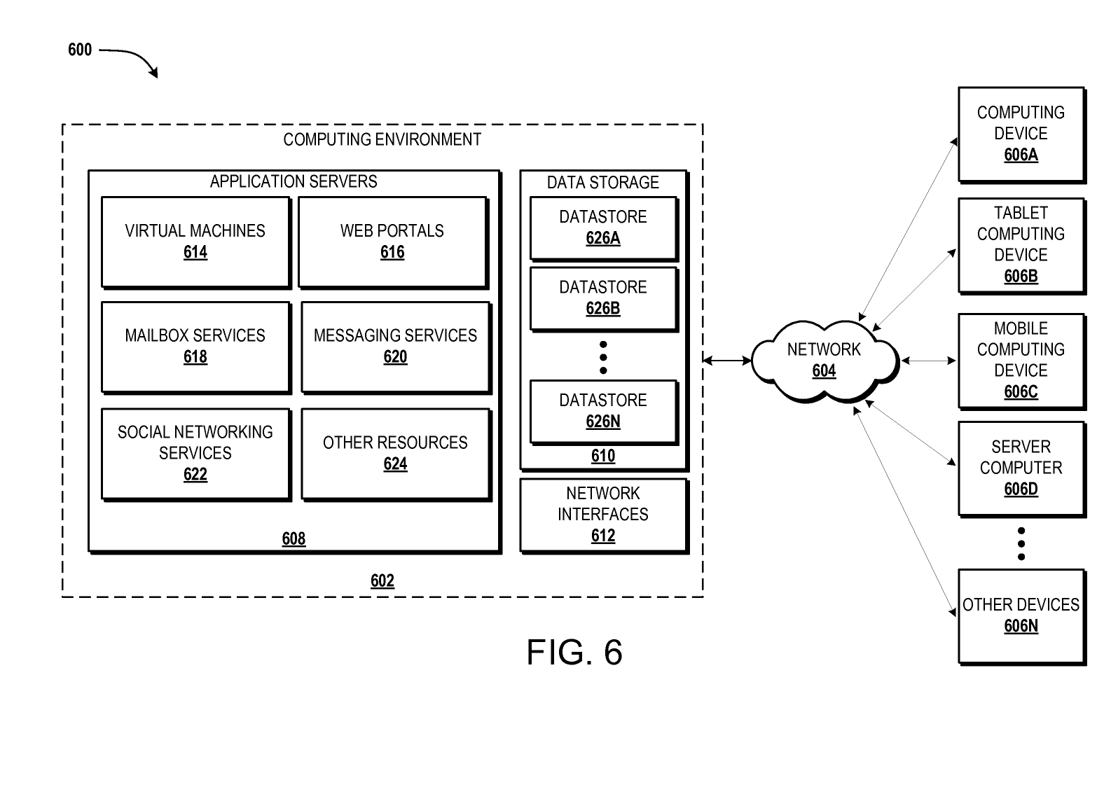

FIG. 6 depicts an illustrative distributed computing environment 600 capable of executing the software components described herein for providing enhanced coding and decoding of geometric data, among other aspects. Thus, the distributed computing environment 600 illustrated in FIG. 6 can be utilized to execute any aspects of the software components presented herein. For example, the distributed computing environment 600 can be utilized to execute aspects of the web browser 510, the content manager 105 and/or other software components described herein.

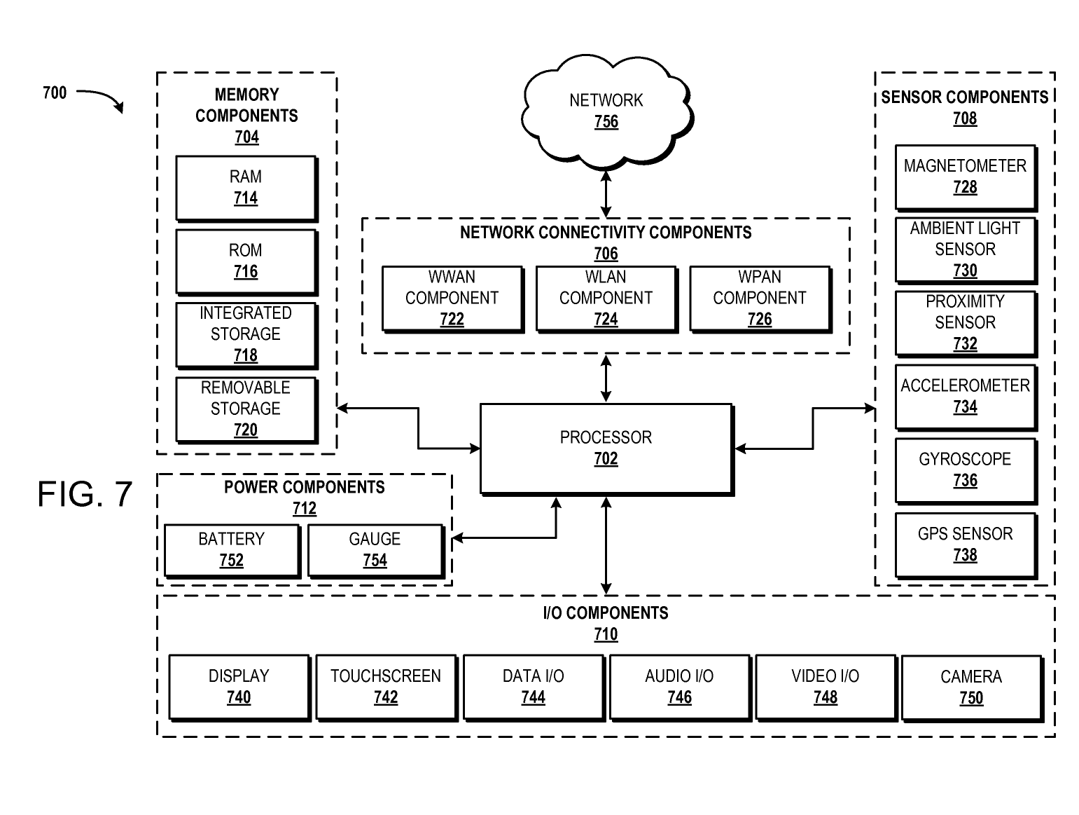

According to various implementations, the distributed computing environment 600 includes a computing environment 602 operating on, in communication with, or as part of the network 604. The network 604 may be or may include the network 756, described above with reference to FIG. 5. The network 604 also can include various access networks. One or more client devices 606A-606N (hereinafter referred to collectively and/or generically as “clients 606”) can communicate with the computing environment 602 via the network 604 and/or other connections (not illustrated in FIG. 6). In one illustrated configuration, the clients 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of clients 606 can communicate with the computing environment 602. Two example computing architectures for the clients 606 are illustrated and described herein with reference to FIGS. 5 and 7. It should be understood that the illustrated clients 606 and computing architectures illustrated and described herein are illustrative, and should not be construed as being limited in any way.

In the illustrated configuration, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated configuration, the application servers 608 host one or more virtual machines 614 for hosting applications or other functionality. According to various implementations, the virtual machines 614 host one or more applications and/or software modules for providing enhanced coding and decoding of geometric data. It should be understood that this configuration is illustrative, and should not be construed as being limiting in any way. The application servers 608 also host or provide access to one or more portals, link pages, Web sites, and/or other information (“Web portals”) 616.

According to various implementations, the application servers 608 also include one or more mailbox services 618 and one or more messaging services 620. The mailbox services 618 can include electronic mail (“email”) services. The mailbox services 618 also can include various personal information management (“PIM”) services including, but not limited to, calendar services, contact management services, collaboration services, and/or other services. The messaging services 620 can include, but are not limited to, instant messaging services, chat services, forum services, and/or other communication services.

The application servers 608 also may include one or more social networking services 622. The social networking services 622 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 622 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 622 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 622 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 622 are not mentioned herein for the sake of brevity. As such, the above configurations are illustrative, and should not be construed as being limited in any way. According to various implementations, the social networking services 622 may host one or more applications and/or software modules for providing the functionality described herein for providing enhanced coding and decoding of geometric data. For instance, any one of the application servers 608 may communicate or facilitate the functionality and features described herein. For instance, a social networking application, mail client, messaging client or a browser running on a phone or any other client 606 may communicate with a networking service 622 and facilitate the functionality, even in part, described above with respect to FIG. 4A and FIG. 4B.

As shown in FIG. 6, the application servers 608 also can host other services, applications, portals, and/or other resources (“other resources”) 624. The other resources 624 can include, but are not limited to, document sharing, rendering or any other functionality. It thus can be appreciated that the computing environment 602 can provide integration of the concepts and technologies disclosed herein provided herein with various mailbox, messaging, social networking, and/or other services or resources.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more server computers configured to host data for the computing environment 602. The data storage 610 can include, host, or provide one or more real or virtual datastores 626A-626N (hereinafter referred to collectively and/or generically as “datastores 626”). The datastores 626 are configured to host data used or created by the application servers 608 and/or other data. Although not illustrated in FIG. 6, the datastores 626 also can host or store web page documents, word documents, presentation documents, data structures, algorithms for execution by a recommendation engine, and/or other data utilized by any application program or another module, such as the content manager 105. Aspects of the datastores 626 may be associated with a service for storing files.

The computing environment 602 can communicate with, or be accessed by, the network interfaces 612. The network interfaces 612 can include various types of network hardware and software for supporting communications between two or more computing devices including, but not limited to, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the clients 606. It should be understood that the clients 606 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 600 to utilize the functionality described herein for providing enhanced coding and decoding of geometric data, among other aspects. In one specific example, as summarized above, techniques described herein may be implemented, at least in part, by the web browser application 510 of FIG. 5, which works in conjunction with the application servers 608 of FIG. 6.

Turning now to FIG. 7, an illustrative computing device architecture 700 for a computing device that is capable of executing various software components described herein for providing enhanced coding and decoding of geometric data. The computing device architecture 700 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. The computing device architecture 700 is applicable to any of the clients 606 shown in FIG. 6. Moreover, aspects of the computing device architecture 700 may be applicable to traditional desktop computers, portable computers (e.g., laptops, notebooks, ultra-portables, and netbooks), server computers, and other computer systems, such as described herein with reference to FIG. 5. For example, the single touch and multi-touch aspects disclosed herein below may be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individuals components illustrated in FIG. 7, the components can interact to carry out device functions. In some configurations, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, a touch-enabled input.

In some configurations, the processor 702 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 702 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some configurations, the processor 702 is fabricated, in part, utilizing a package-on-package (“PoP”) integrated circuit packaging technique. The processor 702 may be a single core or multi-core processor.

The processor 702 may be created in accordance with an ARM architecture, available for license from ARM HOLDINGS of Cambridge, United Kingdom. Alternatively, the processor 702 may be created in accordance with an x86 architecture, such as is available from INTEL CORPORATION of Mountain View, Calif. and others. In some configurations, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some configurations, the RAM 714 or a portion thereof, the ROM 716 or a portion thereof, and/or some combination the RAM 714 and the ROM 716 is integrated in the processor 702. In some configurations, the ROM 716 is configured to store a firmware, an operating system or a portion thereof (e.g., operating system kernel), and/or a bootloader to load an operating system kernel from the integrated storage 718 and/or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some configurations, the removable storage 720 is provided in lieu of the integrated storage 718. In other configurations, the removable storage 720 is provided as additional optional storage. In some configurations, the removable storage 720 is logically combined with the integrated storage 718 such that the total available storage is made available as a total combined storage capacity. In some configurations, the total combined capacity of the integrated storage 718 and the removable storage 720 is shown to a user instead of separate storage capacities for the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various configurations, the operating system includes, but is not limited to WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from the network 756 or another network, which may be a WWAN, a WLAN, or a WPAN. Although only the network 756 is illustrated, the network connectivity components 706 may facilitate simultaneous communication with multiple networks, including the network 604 of FIG. 6. For example, the network connectivity components 706 may facilitate simultaneous communications with multiple networks via one or more of a WWAN, a WLAN, or a WPAN.

The network 756 may be or may include a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 756 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 756 may be configured to provide voice and/or data communications with any combination of the above technologies. The network 756 may be configured to or adapted to provide voice and/or data communications in accordance with future generation technologies.

In some configurations, the WWAN component 722 is configured to provide dual-multi-mode connectivity to the network 756. For example, the WWAN component 722 may be configured to provide connectivity to the network 756, wherein the network 756 provides service via GSM and UMTS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 756 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 724 is configured to connect to the network 756 via the WI-FI access points. Such connections may be secured via various encryption technologies including, but not limited, WI-FI Protected Access (“WPA”), WPA2, Wired Equivalent Privacy (“WEP”), and the like.

The network 756 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 726 is configured to facilitate communications with other devices, such as peripherals, computers, or other computing devices via the WPAN.

The sensor components 708 include a magnetometer 728, an ambient light sensor 730, a proximity sensor 732, an accelerometer 734, a gyroscope 736, and a Global Positioning System sensor (“GPS sensor”) 738. It is contemplated that other sensors, such as, but not limited to, temperature sensors or shock detection sensors, also may be incorporated in the computing device architecture 700.

The magnetometer 728 is configured to measure the strength and direction of a magnetic field. In some configurations the magnetometer 728 provides measurements to a compass application program stored within one of the memory components 704 in order to provide a user with accurate directions in a frame of reference including the cardinal directions, north, south, east, and west. Similar measurements may be provided to a navigation application program that includes a compass component. Other uses of measurements obtained by the magnetometer 728 are contemplated.

The ambient light sensor 730 is configured to measure ambient light. In some configurations, the ambient light sensor 730 provides measurements to an application program stored within one the memory components 704 in order to automatically adjust the brightness of a display (described below) to compensate for low-light and high-light environments. Other uses of measurements obtained by the ambient light sensor 730 are contemplated.

The proximity sensor 732 is configured to detect the presence of an object or thing in proximity to the computing device without direct contact. In some configurations, the proximity sensor 732 detects the presence of a user's body (e.g., the user's face) and provides this information to an application program stored within one of the memory components 704 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 732 are contemplated.

The accelerometer 734 is configured to measure proper acceleration. In some configurations, output from the accelerometer 734 is used by an application program as an input mechanism to control some functionality of the application program. For example, the application program may be a video game in which a character, a portion thereof, or an object is moved or otherwise manipulated in response to input received via the accelerometer 734. In some configurations, output from the accelerometer 734 is provided to an application program for use in switching between landscape and portrait modes, calculating coordinate acceleration, or detecting a fall. Other uses of the accelerometer 734 are contemplated.

The gyroscope 736 is configured to measure and maintain orientation. In some configurations, output from the gyroscope 736 is used by an application program as an input mechanism to control some functionality of the application program. For example, the gyroscope 736 can be used for accurate recognition of movement within a 3D environment of a video game application or some other application. In some configurations, an application program utilizes output from the gyroscope 736 and the accelerometer 734 to enhance control of some functionality of the application program. Other uses of the gyroscope 736 are contemplated.

The GPS sensor 738 is configured to receive signals from GPS satellites for use in calculating a location. The location calculated by the GPS sensor 738 may be used by any application program that requires or benefits from location information. For example, the location calculated by the GPS sensor 738 may be used with a navigation application program to provide directions from the location to a destination or directions from the destination to the location. Moreover, the GPS sensor 738 may be used to provide location information to an external location-based service, such as E911 service. The GPS sensor 738 may obtain location information generated via WI-FI, WIMAX, and/or cellular triangulation techniques utilizing one or more of the network connectivity components 706 to aid the GPS sensor 738 in obtaining a location fix. The GPS sensor 738 may also be used in Assisted GPS (“A-GPS”) systems.

The I/O components 710 include a display 740, a touchscreen 742, a data I/O interface component (“data I/O”) 744, an audio I/O interface component (“audio I/O”) 746, a video I/O interface component (“video I/O”) 748, and a camera 750. In some configurations, the display 740 and the touchscreen 742 are combined. In some configurations two or more of the data I/O component 744, the audio I/O component 746, and the video I/O component 748 are combined. The I/O components 710 may include discrete processors configured to support the various interface described below, or may include processing functionality built-in to the processor 702.

The display 740 is an output device configured to present information in a visual form. In particular, the display 740 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 740 is a liquid crystal display (“LCD”) utilizing any active or passive matrix technology and any backlighting technology (if used). In some configurations, the display 740 is an organic light emitting diode (“OLED”) display. Other display types are contemplated.

The touchscreen 742, also referred to herein as a “touch-enabled screen,” is an input device configured to detect the presence and location of a touch. The touchscreen 742 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 742 is incorporated on top of the display 740 as a transparent layer to enable a user to use one or more touches to interact with objects or other information presented on the display 740. In other configurations, the touchscreen 742 is a touch pad incorporated on a surface of the computing device that does not include the display 740. For example, the computing device may have a touchscreen incorporated on top of the display 740 and a touch pad on a surface opposite the display 740.

In some configurations, the touchscreen 742 is a single-touch touchscreen. In other configurations, the touchscreen 742 is a multi-touch touchscreen. In some configurations, the touchscreen 742 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 742. As such, a developer may create gestures that are specific to a particular application program.

In some configurations, the touchscreen 742 supports a tap gesture in which a user taps the touchscreen 742 once on an item presented on the display 740. The tap gesture may be used for various reasons including, but not limited to, opening or launching whatever the user taps. In some configurations, the touchscreen 742 supports a double tap gesture in which a user taps the touchscreen 742 twice on an item presented on the display 740. The double tap gesture may be used for various reasons including, but not limited to, zooming in or zooming out in stages. In some configurations, the touchscreen 742 supports a tap and hold gesture in which a user taps the touchscreen 742 and maintains contact for at least a pre-defined time. The tap and hold gesture may be used for various reasons including, but not limited to, opening a context-specific menu.

In some configurations, the touchscreen 742 supports a pan gesture in which a user places a finger on the touchscreen 742 and maintains contact with the touchscreen 742 while moving the finger on the touchscreen 742. The pan gesture may be used for various reasons including, but not limited to, moving through screens, images, or menus at a controlled rate. Multiple finger pan gestures are also contemplated. In some configurations, the touchscreen 742 supports a flick gesture in which a user swipes a finger in the direction the user wants the screen to move. The flick gesture may be used for various reasons including, but not limited to, scrolling horizontally or vertically through menus or pages. In some configurations, the touchscreen 742 supports a pinch and stretch gesture in which a user makes a pinching motion with two fingers (e.g., thumb and forefinger) on the touchscreen 742 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 742. As such, the above gestures should be understood as being illustrative and should not be construed as being limiting in any way.

The data I/O interface component 744 is configured to facilitate input of data to the computing device and output of data from the computing device. In some configurations, the data I/O interface component 744 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 746 is configured to provide audio input and/or output capabilities to the computing device. In some configurations, the audio I/O interface component 746 includes a microphone configured to collect audio signals. In some configurations, the audio I/O interface component 746 includes a headphone jack configured to provide connectivity for headphones or other external speakers. In some configurations, the audio I/O interface component 746 includes a speaker for the output of audio signals. In some configurations, the audio I/O interface component 746 includes an optical audio cable out.

The video I/O interface component 748 is configured to provide video input and/or output capabilities to the computing device. In some configurations, the video I/O interface component 748 includes a video connector configured to receive video as input from another device (e.g., a video media player such as a DVD or BLURAY player) or send video as output to another device (e.g., a monitor, a television, or some other external display). In some configurations, the video I/O interface component 748 includes a High-Definition Multimedia Interface (“HDMI”), mini-HDMI, micro-HDMI, DisplayPort, or proprietary connector to input/output video content. In some configurations, the video I/O interface component 748 or portions thereof is combined with the audio I/O interface component 746 or portions thereof.

The camera 750 can be configured to capture still images and/or video. The camera 750 may utilize a charge coupled device (“CCD”) or a complementary metal oxide semiconductor (“CMOS”) image sensor to capture images. In some configurations, the camera 750 includes a flash to aid in taking pictures in low-light environments. Settings for the camera 750 may be implemented as hardware or software buttons.

Although not illustrated, one or more hardware buttons may also be included in the computing device architecture 700. The hardware buttons may be used for controlling some operational aspect of the computing device. The hardware buttons may be dedicated buttons or multi-use buttons. The hardware buttons may be mechanical or sensor-based.

The illustrated power components 712 include one or more batteries 752, which can be connected to a battery gauge 754. The batteries 752 may be rechargeable or disposable. Rechargeable battery types include, but are not limited to, lithium polymer, lithium ion, nickel cadmium, and nickel metal hydride. Each of the batteries 752 may be made of one or more cells.

The battery gauge 754 can be configured to measure battery parameters such as current, voltage, and temperature. In some configurations, the battery gauge 754 is configured to measure the effect of a battery's discharge rate, temperature, age and other factors to predict remaining life within a certain percentage of error. In some configurations, the battery gauge 754 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 712 may also include a power connector, which may be combined with one or more of the aforementioned I/O components 710. The power components 712 may interface with an external power system or charging equipment via an I/O component.

The disclosure presented herein may be considered in view of the following clauses.

Clause 1: A computer-implemented method, the method including obtaining geometric data; obtaining video data; partitioning the geometric data into individual geometric data partitions associated with individual frames; generating individual network abstraction layer-compliant geometric data partitions from the individual geometric data partitions; partitioning the video data into individual video data partitions associated with the individual frames; and integrating the individual network abstraction layer-compliant geometric data partitions with the individual video data partitions into a network abstraction layer of a bit stream in a conformant way against a video coding standard and a file format standard.

Clause 2: The method of clause 1, further including parsing the bit stream to extract the individual network abstraction layer-compliant geometric data partitions and the individual video data partitions; generating the individual geometric data partitions from the individual network abstraction layer-compliant geometric data partitions; processing the individual geometric data partitions to generate the geometric data; and processing the individual video data partitions to generate the video data.

Clause 3: The method of clauses 1-2, wherein an individual network abstraction layer-compliant geometric data partition and an individual video data partition are associated with a frame and are arranged in consecutive positions of the bit stream, synchronized in time positions.

Clause 4: The method of clauses 1-3, wherein the bit stream contains a first network abstraction layer-compliant geometric data partition that is dependent on, and positioned within a threshold unit from, a second network abstraction layer-compliant geometric data partition.

Clause 5: The method of clauses 1-4, wherein the threshold unit is a pre-determined number of milliseconds.

Clause 6: The method of clauses 1-5, wherein the threshold unit is a pre-determined number of partitions.

Clause 7: The method of clauses 1-6, wherein the network abstraction layer of the bit stream includes a network abstraction layer-compliant geometric data partition positioned after a sequence header, a picture header, and a plurality of slice headers, conformant to a video coding standard and a file format standard.

Clause 8: A computing device, including a processor; and a computer-readable storage medium in communication with the processor, the computer-readable storage medium having computer-executable instructions stored thereupon which, when executed by the processor, cause the computing device to obtain geometric data; obtain video data; partition the geometric data into individual geometric data partitions associated with individual frames; generate individual network abstraction layer-compliant geometric data partitions from the individual geometric data partition; partition the video data into individual video data partitions associated with the individual frames; and integrate the individual network abstraction layer-compliant geometric data partitions with the individual video data partitions into a network abstraction layer of a bit stream.

Clause 9: The computing device of clause 8, wherein the computer-readable storage medium has further computer-executable instructions stored thereon that cause the computing device to: parse the bit stream to extract the individual network abstraction layer-compliant geometric data partitions and the individual video data partitions; generate the individual geometric data partitions from the individual network abstraction layer-compliant geometric data partitions; process the individual geometric data partitions to generate the geometric data; and process the individual video data partitions to generate the video data.

Clause 10: The computing device of clauses 8-9, wherein an individual network abstraction layer-compliant geometric data partition and an individual video data partition are associated with a frame and are arranged in consecutive positions of the bit stream.

Clause 11: The computing device of clauses 8-10, wherein the bit stream contains a first network abstraction layer-compliant geometric data partition that is dependent on, and positioned within a threshold unit from, a second network abstraction layer-compliant geometric data partition.

Clause 12: The computing device of clauses 8-11, wherein the threshold unit is a pre-determined number of partitions.

Clause 13: The computing device of clauses 8-12, wherein the threshold unit is a pre-determined number of milliseconds.

Clause 14: The computing device of clauses 8-13, wherein the network abstraction layer of the bit stream includes a network abstraction layer-compliant geometric data partition positioned after a sequence header, a picture header, and a plurality of slice headers.

Clause 15: A computer-readable storage medium having computer-executable instructions stored thereupon which, when executed by a computer, cause the computer to: obtain geometric data; obtain video data; partition the geometric data into individual geometric data partitions associated with individual frames; generate individual network abstraction layer-compliant geometric data partitions from the individual geometric data partition; partition the video data into individual video data partitions associated with the individual frames; and integrate the individual network abstraction layer-compliant geometric data partitions with the individual video data partitions into a network abstraction layer of a bit stream.

Clause 16: The computer-readable storage medium of clause 15, wherein the computer-readable storage medium has further computer-executable instructions stored thereon that cause the computer to: parse the bit stream to extract the individual network abstraction layer-compliant geometric data partitions and the individual video data partitions; generate the individual geometric data partitions from the individual network abstraction layer-compliant geometric data partitions; process the individual geometric data partitions to generate the geometric data; and process the individual video data partitions to generate the video data.

Clause 17: The computer-readable storage medium of clauses 15-16, wherein an individual network abstraction layer-compliant geometric data partition and an individual video data partition are associated with a frame and are arranged in consecutive positions of the bit stream.

Clause 18: The computer-readable storage medium of clauses 15-17, wherein the bit stream contains a first network abstraction layer-compliant geometric data partition that is dependent on, and positioned within a threshold unit from, a second network abstraction layer-compliant geometric data partition.

Clause 19: The computer-readable storage medium of clauses 15-18, wherein the threshold unit is a pre-determined number of milliseconds.

Clause 20: The computer-readable storage medium of clauses 15-19, wherein the network abstraction layer of the bit stream includes a network abstraction layer-compliant geometric data partition positioned after a sequence header, a picture header, and a plurality of slice headers.

Based on the foregoing, it should be appreciated that concepts and technologies described herein provide enhanced coding and decoding of geometric data. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

1. A computer-implemented method, the method comprising:
obtaining geometric data;
obtaining video data;
partitioning the geometric data into individual geometric data partitions associated with individual frames;
generating individual network abstraction layer-compliant geometric data partitions from the individual geometric data partitions;
partitioning the video data into individual video data partitions associated with the individual frames; and
integrating the individual network abstraction layer-compliant geometric data partitions with the individual video data partitions into a network abstraction layer of a bit stream conformant to a video coding standard and a file format standard.

2. The method of claim 1, further comprising:
parsing the bit stream to extract the individual network abstraction layer-compliant geometric data partitions and the individual video data partitions;
generating the individual geometric data partitions from the individual network abstraction layer-compliant geometric data partitions;
processing the individual geometric data partitions to generate the geometric data; and
processing the individual video data partitions to generate the video data.

3. The method of claim 1, wherein an individual network abstraction layer-compliant geometric data partition and an individual video data partition are associated with a frame and are arranged in consecutive positions of the bit stream, synchronized in time positions.

4. The method of claim 1, wherein the bit stream contains a first network abstraction layer-compliant geometric data partition that is dependent on, and positioned within a threshold unit from, a second network abstraction layer-compliant geometric data partition.

5. The method of claim 4, wherein the threshold unit is a pre-determined number of milliseconds.

6. The method of claim 4, wherein the threshold unit is a pre-determined number of partitions.

7. The method of claim 1, wherein the network abstraction layer of the bit stream includes a network abstraction layer-compliant geometric data partition positioned after a sequence header, a picture header, and a plurality of slice headers, conformant to a video coding standard and a file format standard.

8. A computing device, comprising:
a processor; and
a computer-readable storage medium in communication with the processor, the computer-readable storage medium having computer-executable instructions stored thereupon which, when executed by the processor, cause the computing device to
receive a bit stream comprising individual abstraction layer-compliant geometric data partitions and individual video data partitions associated with individual frames;
parse the bit stream to extract the individual abstraction layer-compliant geometric data partitions and the individual video data partitions;
generate individual geometric data partitions from the individual abstraction layer-compliant geometric data partitions;
process the individual geometric data partitions to generate geometric data; and
process the individual video data partitions to generate video data.

9. (canceled)

10. The computing device of claim 8, wherein at least one individual abstraction layer-compliant geometric data partition and at least one individual video data partition are associated with a frame and are arranged in consecutive positions of the bit stream.

11. The computing device of claim 8, wherein the bit stream contains a first abstraction layer-compliant geometric data partition that is dependent on, and positioned within a threshold unit from, a second abstraction layer-compliant geometric data partition.

12. The computing device of claim 11, wherein the threshold unit is a pre-determined number of partitions.

13. The computing device of claim 11, wherein the threshold unit is a pre-determined number of milliseconds.

14. The computing device of claim 8, wherein the abstraction layer of the bit stream includes an abstraction layer-compliant geometric data partition positioned after a sequence header, a picture header, and a plurality of slice headers.

15. A computer-readable storage medium having computer-executable instructions stored thereupon which, when executed by a computer, cause the computer to:
obtain geometric data;
obtain video data;
partition the geometric data into individual geometric data partitions associated with individual frames;
generate individual network abstraction layer-compliant geometric data partitions from the individual geometric data partition;
partition the video data into individual video data partitions associated with the individual frames; and
integrate the individual network abstraction layer-compliant geometric data partitions with the individual video data partitions into a network abstraction layer of a bit stream.

16. The computer-readable storage medium of claim 15, wherein the computer-readable storage medium has further computer-executable instructions stored thereon that cause the computer to:
parse the bit stream to extract the individual network abstraction layer-compliant geometric data partitions and the individual video data partitions;
generate the individual geometric data partitions from the individual network abstraction layer-compliant geometric data partitions;
process the individual geometric data partitions to generate the geometric data; and
process the individual video data partitions to generate the video data.

17. The computer-readable storage medium of claim 15, wherein an individual network abstraction layer-compliant geometric data partition and an individual video data partition are associated with a frame and are arranged in consecutive positions of the bit stream.

18. The computer-readable storage medium of claim 15, wherein the bit stream contains a first network abstraction layer-compliant geometric data partition that is dependent on, and positioned within a threshold unit from, a second network abstraction layer-compliant geometric data partition.

19. The computer-readable storage medium of claim 18, wherein the threshold unit is a pre-determined number of milliseconds.

20. The computer-readable storage medium of claim 15, wherein the network abstraction layer of the bit stream includes a network abstraction layer-compliant geometric data partition positioned after a sequence header, a picture header, and a plurality of slice headers.

21. The computer-readable storage medium of claim 18, wherein the threshold unit is a pre-determined number of partitions.
